(19) United States
(12) Patent Application Publication
(10) Pub. No.: US 2024/0218570 A1
(43) Pub. Date: Jul. 4, 2024

(54) DESIGN AND PRODUCTION OF SUSTAINABLE AND BIODEGRADABLE WOVEN FABRIC WITH RENEWABLE PLA (POLYLACTIC ACID) FIBER

(71) Applicant: MENDERES TEKSTIL SAN. VE TIC. A.S., Denizli (TR)

(72) Inventors: Serdar Kaymakci, Denizli (TR); Serkan Alsan, Denizli (TR); Sueleyman Ilker Ertuna, Denizli (TR); Fatma Ipek, Denizli (TR); Ceren Goede, Denizli (TR); Yusuf Guengoer, Denizli (TR)

(21) Appl. No.: 17/998,829

(22) PCT Filed: Oct. 28, 2021
(86) PCT No.: PCT/TR21/51105

§ 371 Date: Jan. 12, 2023

(30) Foreign Application Priority Data
Jul. 9, 2021 (TR) 2021/011287

(51) Int. Cl. D02G 3/02; D02J 7/00

(52) U.S. Cl. CPC D02G 3/02; D02J 7/00; D10B 2331/041; D10B 2401/12

(57) ABSTRACT

The invention relates to a method for obtaining environmentally-friendly, sustainable, and biodegradable yarns by subjecting the PLA (polylactic acid), which is used in many different sectors such as the food packaging industry, health and medical industry, construction industry, cosmetic industry, and textile industry, to a variety of procedure steps with the open-end method, and a new fabric to be used in the textile sector thanks to the weaving of the said yarns.

### TECHNICAL FIELD

The invention relates to a method for obtaining environmentally-friendly, sustainable, and biodegradable yarns by subjecting the PLA (polylactic acid), which is used in many different sectors such as the food packaging industry, health and medical industry, construction industry, cosmetic industry, and textile industry, to a variety of procedure steps with the open-end method, and a new fabric to be used in the textile sector thanks to the weaving of the said yarns.

### BACKGROUND ART

PLA is a polymer from the group of aliphatic polyesters synthesized from alpha-hydroxy acids. Known to be environmentally friendly, PLA is synthesized by condensation polymerization of lactic acid obtained from renewable resources (corn, wheat, rice . . . ). It is a biocompatible and recyclable polymer. PLA converts into harmless and natural products by hydrolyzing, without the need for an enzyme. Despite some disadvantages such as slow degradation rate, hydrophobicity, and lack of reactive side groups, PLA is a crucial polymer in both industrial and biological fields. It has better thermal processability compared to most biopolymers including poly(hydroxy alkanoate) (PHA), poly(ethylene glycol) (PEG), and poly(ε-caprolactone) (PCL). An important element in biomedical applications such as surgical sutures, bone fixation, drug delivery, and tissue engineering, PLA enters into the tricarboxylic acid cycle by hydrolyzing to its constituent alpha-hydroxy acids when in living organisms and is then excreted from the body. Lactic acid homopolymer and copolymers are synthesized by condensation polymerization and ring-opening polymerization (ROP) methods. For the past 25 years, PLA has been widely used in medical practice. Bioplastics provide a growing market with opportunities for the creation and development of rural areas. Europe estimates that by 2030, up to 300,000 high-skilled jobs will be created in the European bioplastics market, 10 times higher than the current number of employees in this sector.

As summarized above, PLA is widely employed in controlled drug delivery systems because of its compatibility with the body. Controlled drug delivery systems ensure that the drug is delivered to the body in the required amount and at a constant release rate. PLA can be implanted in soft tissues and bone tissues thanks to its mechanical properties and absorption capacity. While some implantable devices (hip and kneecap attachment devices, heart valves) are placed in the body to be used permanently, others (such as fracture fixation devices and controlled drug delivery devices) are used therein for a temporary period. Lactic acid polymers can be processed by a variety of methods since they show thermoplastic behavior. Fiber drawing, extrusion, and molding are the most common ones among these methods.

However, in injection molding, some technical problems occur during production because polylactic acid (PLA) is a rigid and brittle material with around 3-4% elongation at break. On the other hand, converting the PLA material into fiber presents a completely different situation. The fibers obtained are silky and the fabrics produced with these fibers are also soft, having a pleasant structure caressing the skin. Depending on the stretch, elongation at break can be increased to 20-200%.

Some scientists believe that freshwater will be one of humanity's most limited resources soon. It strikes attention that, except for wool, which requires almost no water, PLA fibers are advantageous particularly over petrochemical products such as PET and cellulose-based fibers. Cotton is a fiber that requires the highest amount of water. This is also due to the high irrigation demand of the cotton plant. Crops for PLA production generally require almost no irrigation. Moreover, PLA is also known to have an impact on reducing greenhouse gases. As a result, PLA is clearly superior to not only petrochemical polymers but also natural fibers such as cotton. Furthermore, the plastics industry endeavors to replace non-renewable polyester textiles with bio-sourced PLA fiber in the textile industry. Its advantages include breathability, lower weight, and recyclability.

An examination of the prior art shows that PLA used in the textile industry is generally manufactured by melt spinning process. Dyeing fibers and textiles produced from PLA, on the other hand, is one of the biggest challenges. PLA can be dyed with disperse dye method applied for PET. However, due to the limited hydrolysis resistance of disperse dyes in liquid, dyeing temperature should not exceed 100° C. A decrease in physical properties such as strength and flexibility, as well as dye affinity of the PLA-based fabric surface, can be encountered. Other dyeing methods should, therefore, be considered for PLA fiber. In particular, there has been a need for methods that would allow softer and kinder treatments on PLA fibers. Dyeing can be performed during fiber drawing; however, this may be suitable only for high-volume yarns and it is a method that will certainly yield unsuccessful results in low-volume yarns. Since there are different production stages in the textile production line, some technical problems may be faced in procedures such as weaving, knitting, and sewing when only a portion of fiber becomes ready after fiber drawing.

Described in document no. TR2019/21149, the invention is summarized as follows: “A nonwoven fabric comprising a plurality of polylactic acid-containing fibers that form a nonwoven web is disclosed herein. The web has a side provided with an alternating pattern of individualized bonded areas. The bonded areas are in the form of linear rods. The rods are arranged in such a way that no uninterrupted region exists along the web which is in the machine direction while in the cross direction of the web, the arrangement of the rods defines a plurality of uninterrupted regions that extend continuously along the web. The alternating pattern of bonded areas defines a non-bonded area. The weight of the web is 5-50 g/m2. The surface of the bonded areas is 5-20% of the total surface of the side, and the surface of the non-bonded area is 80-95% of the total surface of the side. Procedures for forming the nonwoven fabric, absorbent articles comprising the nonwoven fabric, and the use of the nonwoven fabric in absorbent articles are also disclosed.” The concerned application mentions a nonwoven fabric. However, our current application relates to a woven fabric.

Described in document no. CN202450227, the invention is summarized as follows: “It provides polylactic acid (PLA) fiber and wool blended elastic fabric. The PLA fiber and wool blended elastic fabric is woven by warps and wefts, wherein the warps are PLA fiber/wool blended double-strand yarns; the wefts comprise first wefts and second wefts; the first wefts are PLA fiber/wool blended double-strand yarn and lycra spandex bales; the second wefts are sequined yarn and polyester filament yarn twisted and PLA fiber/wool blended yarn bales.”

Described in document no. TR2021/001895, the invention is summarized as follows: “Nonwoven fabrics comprising a plurality of fibers that are bonded to each other to form a coherent web, wherein the fibers comprise a blend of a polylactic acid (PLA) and at least one secondary alkane sulfonate. The nonwoven fabrics exhibit an increase in tensile strength, elongation, and toughness.”

Described in document no. TR2020/17717, the invention is summarized as follows: “In particular, the invention relates to a mask comprising an outer layer and an inner layer made of polylactic acid spunbond nonwoven fabric, and a middle layer made of polylactic acid meltblown nonwoven fabric.”

Described in document no. JP2005232645, the invention is summarized as follows: “It relates to a method for providing and producing a polylactic acid fiber having biodegradability, light-weight and heat-insulating property, high hollowness and remarkably improved strength, abrasion resistance, etc.”

In conclusion, the requirement for the elimination of shortcomings and disadvantages of embodiments and practices existing in the prior art and already being used as of today entails an improvement in the respective technical field.

### DESCRIPTION OF THE INVENTION

The present invention relates to a yarn production method with 100% open-end method and a fabric manufactured with the said yarn, wherein it is developed for eliminating the aforementioned disadvantages and providing new advantages to the respective technical field.

An objective of the present invention is to produce a yarn that, in this world where our limited natural resources are being depleted, prevents waste of water, ensures the most efficient use of water, and has the properties of higher durability, natural UV resistance, non-flammability, and less smoke-generation, and to create a fabric woven with this yarn.

Another objective of the present invention is to ensure that the PLA that is turned into a wearable textile product can perfectly remove moisture from the skin.

A further objective of the present invention is to be able to process PLA in the polyester fiber, filament, interlining machines that are currently in use, and thereby achieve economic production without any extra cost.

Another objective of the present invention is to ensure the use of easy-to-shape PLA that can be melted and reshaped without significantly deteriorating its mechanical properties, thanks to its thermoplasticity. PLA can thus be mechanically recycled.

A further objective of the present invention is to provide a biodegradable product that does not lead to situations endangering the environment and human health during its production and at the time of its expiration.

Another objective of the present invention is to use a polymer with good mechanical properties when compared to conventional polymers such as polypropylene, polystyrene, and polyurethane. Especially when it comes to Young's modulus (the ability to tolerate elongation under tension or compression), tensile strength (the force required to pull something), and yield strength (the stress required to initiate plastic deformation).

Another objective of the present invention is to obtain high production speed for the manufacturing of the said yarns thanks to the use of the open-end yarn spinning method, compared to ring spinning systems. This is a factor enabling cost reduction while increasing production.

A further objective of the present invention is to reduce procedure times thanks to the use of the open-end yarn spinning method in the manufacturing of the said yarns. This directly reduces costs.

Another objective of the present invention is to provide yarns with such advantages as being bulkier, more elastic, and more absorbent, and having less hairiness, thanks to the use of the open-end yarn spinning method, compared to ring spinning. Moreover, good absorbency, high size take-up percentage, and brighter tones are provided also thanks to the open-end production method.

A further objective of the present invention is to minimize the variation along the yarn in terms of fineness, irregularity, durability, etc. of PLA fiber thanks to this preferred method of production.

### DETAILED EXPLANATION OF THE INVENTION

The preferred alternatives in this detailed description of the embodiment of the present disclosure are only intended for providing a better understanding of the subject matter and should not be construed in any restrictive sense.

The invention relates to a yarn manufactured from 100% PLA (polylactic acid) with the open-end method and the production of fabric obtained by the weaving of the said yarns.

Open-end yarn spinning system is a completely different production technique compared to ring spinning. Unlike the ring spinning method, short fibers of PLA are used in this technique. Benefitting from even the shortest fibers of PLA during the production procedure, this yarn is quite economic. In order to ensure integrity, the number of twists must be higher in comparison to the ring system. In general, the method includes:
1—Opening and cleaning the fiber mass that is received in the form of sliver until individual fibers are obtained.
2—Collecting the fibers in parallel and twisting them.
3—Obtaining the desired number of yarns.
4—Wrapping up the obtained yarn on a bobbin.

1.33 dtex/38 mm 100% PLA fiber is taken from the blowroom production line to manufacture yarn in open-end machines.

The production method of the invention consists of the following procedure steps:
PLA fiber is subjected to the blowroom system to ensure that PLA fiber is made even and cleaned roughly.
PLA fiber taken from the blowroom system arrives at the carding machine, and fibers are cleaned and disentangled here.
PLA moved by air from the blowroom system is fed from the chute feed into the taker-in at a fixed amount.
The taker-in feeds these fibers to the cylinder since they rotate in the same direction and the cylinder rotates faster.
It also removes 70-75% of noil and foreign particles arriving at the card.
Carding procedure is performed between the cylinder and the flats.
Carded fiber arrives at the doffer.
Accumulation takes place thanks to the opposing directions of wires, the same direction of rotation, and the higher peripheral speed of the cylinder compared to the peripheral speed of the doffer.
The fiber is removed from the doffer with the stripping system.
In the delivery funnel and calender rollers, the web is collected through the web funnel in the calender rollers and made into a round sliver.
The sliver is brought to the drawing frame to reduce sliver irregularity by way of doubling and drafting, and the whole sliver is homogenized here.
The thickness of slivers is measured by two rollers prior to their entry to the drafting zone.
Feeding is increased or decreased in the case of thinner or thicker slivers.
If the material is thick, then the back rollers are slowed down and the material is fed slowly or the front rollers are accelerated so that this thick part is ensured to be properly drawn.
The slivers coming out of the drawing frame are fed into the cans and these cans are later taken to the open-end machine to be processed.
Fibers subjected to the opening procedure are in the form of individual fibers.
Then, a portion of fiber mass is fed into the rotor and pulled toward the edges by the impact of centrifugal forces; fibers are twisted via yarn-end between twist funnel and rotor wall, and yarn formation is achieved.

All elements in the open-end system are explained hereinbelow.

Blowroom System: PLA is blended in this system. A metal remover helps remove the metal if any. Dust and dirt are removed, PLA is turned into fiber and arrives at the carding system. The blowroom system includes a combination of stages until carding. This system provides a coarse cleaning of the PLA.

Carding Machine: Fibers cleaned and disentangled. PLA moved by air from the blowroom system is fed from the chute feed into the taker-in at a fixed amount. The taker-in feeds these fibers to the cylinder since they rotate in the same direction and the cylinder rotates faster. It also removes 70-75% of noil and foreign particles arriving at the card. Carding procedure is performed between the cylinder and the flats which becomes possible thanks to the opposing directions of clothing wires, the same direction of rotation, and the higher peripheral speed of the cylinder compared to the peripheral speed of the doffer. Carded fiber arrives at the doffer. Accumulation takes place thanks to the opposing directions of wires, the same direction of rotation, and the higher peripheral speed of the cylinder compared to the peripheral speed of the doffer. The fiber is removed from the doffer with the stripping system. In the delivery funnel and calender rollers, the web is collected through the web funnel in the calender rollers and made into a round sliver.

Drawing Frame: Sliver irregularity is reduced by way of doubling and drafting. Different slivers are blended by doubling.

Unlike the first passage drawing frames, the second passage drawing frames consist of a regulation apparatus. Since this is the last machine before the open-end structure, the whole sliver is aimed to be homogenized here.

Working Principle of Regulation Apparatus: The thickness of slivers is measured by two rollers prior to their entry to the drafting zone. Feeding is increased or decreased in the case of thinner or thicker slivers. If the material is thick, then the back rollers are slowed down and the material is fed slowly or the front rollers are accelerated so that this thick part is ensured to be properly drawn.

Open-end Yarn Machine: The slivers coming out of the drawing frame are fed into the cans and these cans are later taken to the open-end machine to be processed. Fibers subjected to the opening procedure are in the form of individual fibers. Then, a portion of fiber mass is fed into the rotor and pulled toward the edges by the impact of centrifugal forces; fibers are twisted via yarn-end between twist funnel and rotor wall. Yarn formation is thus achieved.

Problems have been encountered over the course of working with PLA fiber in drawing frames. Due to the low melting temperature of PLA fiber, fiber breaks occurred upon heat generation because of friction and subsequent hardening in the relevant regions. The breaks in the fiber negatively affect the yarn quality. This leads to low strength in fibers. Therefore, regulation apparatus is opened to prevent frictions.

Below are the final values obtained by the used machines allowing to overcome all technical problems.

TABLE 1
30 NE 100% PLA (DAVEN LTD)
FIBER DETAILS

| | MICRONAIRE | LENGTH | | | | | | MOIST |
|---|---|---|---|---|---|---|---|---|
| LOT | FINENESS | mm | UNF | SFI | STR | ELG | COLOR | % |
| PLA | 4 | 37.49 | 94.9 | 2.6 | 58 | 21.3 | | 8.8 |
| NOTES: | | | | | | | | |

| BLOWROOM | | | | WASTE ROOM | | | | |
|---|---|---|---|---|---|---|---|---|
| | AFC GRID | CLC4 | ERM | | VERTICAL | PORCUPINE | USED FIBERS | |
| LINE | SETTING | WING | DEV. | AFC | OPENER | OPENER | LOT | KG |
| SYNTHETIC | | | 870 | | | | PLA | 185 |

| CARDS | 27 | | | | | | | | |
|---|---|---|---|---|---|---|---|---|---|
| TAKER-IN | BACK FIXED | REVOLVING | FRONT FIXED | CYLINDER | TAKER-IN | CYLINDER | FLATS | OUTPUT | |
| CYLINDER | FLATS | FLATS | FLATS | DOFFER | REVOLUTION | REVOLUTION | SPEED | SPEED | NE |
| 8 | 25-20-19-18- | 1000/2 | 14-14-14-14- | 8 | 115 | 475 | 180 | 80 | 0.1 |
| | 16-16-15 | | 14-14 | | | | | | |

1ST PASSAGE DRAWING: 29

| ROLLER SETTING | DRAFTING | BREAK-DRAFT | DOUBLING | REVOLUTION | NE |
|---|---|---|---|---|---|
| 52-44 | | 1.35 | 6 | 500 | 0.11 |

2ND PASSAGE DRAWING: 30

| ROLLER SETTING | DRAFTING | BREAK-DRAFT | DOUBLING | REVOLUTION | NE |
|---|---|---|---|---|---|
| 53-45 | | 1.35 | 6 | 500 | 0.12 |

OPEN-END

| | | |
|---|---|---|
| NE | 30 | 30 |
| TEST NO | 1 | 1 |
| MACHINE NO | 27(WEFT) | 20(WARP) |
| DATE | 26 May 2021 | 27 May 2021 |
| CARD REVOLUTION | 80 | 80 |
| 1ST PASSAGE NE | 0.11 | 0.11 |
| 2ND PASSAGE NE | 0.12 | 0.12 |
| ROTOR TYPE | S640 | S641 |
| OPENER TYPE | S21 | S21 |
| OPENER REVOLUTION | 6000 | 6600 |
| NAVEL | KSK4 | KSK4 |
| TORQ STOP | WHITE | WHITE |
| DRAFTING | 247 | 247 |
| WINDING TENSION | 100 | 100 |
| WINDING ANGLE | 26 | 30 |
| TWISTING | 862 | 862 |
| ALFAe | 4 | 4 |
| OUTLET SPEED | 63.8 | 63.8 |
| THEORETICAL NE | 30 | 30 |
| NE | 30.23 | 29.88 |
| NE CV | | |
| % CV | 13.26 | 13.64 |
| THIN POINT | 3.1 | 10.5 |
| THICK POINT | 13.8 | 23 |
| NEPS | 0.6 | 5 |
| H | 7.34 | 7.6 |
| Cn/Tex | 11.07 | 11.78 |
| ELG | 16.46 | 16.51 |
| BREAK 100/Rh | | 91 |
| YIELD % | 96 | 96 |

NOTES:
NOTES:
NOTES:
REGULATION CANCELLED. INSPECTION IS ON. WHEN IT IS OFF, AREAS THE MEASURING PLATE TOUCHES ARE HARDENED DUE TO HEAT.

1- A method for obtaining environmentally-friendly, sustainable, and biodegradable yarns by subjecting the PLA (polylactic acid), which is used in many different sectors such as the food packaging industry, health and medical industry, construction industry, cosmetic industry, and textile industry, to a variety of procedure steps with the open-end method, and a new fabric to be used in the textile sector thanks to the weaving of the said yarns, and its feature is that it consists of the following procedure steps:
bringing the PLA fiber first to the blowroom system;
then subjecting it to the carding procedures;
subjecting it to drawing I and drawing II procedures;
finally, completing taking it to the open-end machine to complete the procedures.

2- In accordance with claim 1, a method for obtaining environmentally-friendly, sustainable, and biodegradable yarns by subjecting the PLA (polylactic acid), which is used in many different sectors such as the food packaging industry, health and medical industry, construction industry, cosmetic industry, and textile industry, to a variety of procedure steps with the open-end method, and a new fabric to be used in the textile sector thanks to the weaving of the said yarns, and its feature is that it consists of the following procedure steps:
PLA fiber is subjected to the blowroom system to ensure that PLA fiber is made even and cleaned roughly;
PLA fiber taken from the blowroom system arrives at the carding machine, and fibers are cleaned and disentangled here;
PLA moved by air from the blowroom system is fed from the chute feed into the taker-in at a fixed amount;
The taker-in feeds these fibers to the cylinder since they rotate in the same direction and the cylinder rotates faster;
It also removes 70-75% of noil and foreign particles arriving at the card;
Carding procedure is performed between the cylinder and the flats;
Carded fiber arrives at the doffer;
Accumulation takes place thanks to the opposing directions of wires, the same direction of rotation, and the higher peripheral speed of the cylinder compared to the peripheral speed of the doffer;
The fiber is removed from the doffer with the stripping system;
In the delivery funnel and calender rollers, the web is collected through the web funnel in the calender rollers and made into a round sliver;
The sliver is brought to the drawing frame to reduce sliver irregularity by way of doubling and drafting, and the whole sliver is homogenized here;
The thickness of slivers is measured by two rollers prior to their entry to the drafting zone;
Feeding is increased or decreased in case of thinner or thicker slivers;
If the material is thick, then the back rollers are slowed down and the material is fed slowly or the front rollers are accelerated so that this thick part is ensured to be properly drawn;
The slivers coming out of the drawing frame are fed into the cans and these cans are later taken to the open-end machine to be processed;
Fibers subjected to the opening procedure are in the form of individual fibers;
Then, a portion of fiber mass is fed into the rotor and pulled toward the edges by the impact of centrifugal forces; fibers are twisted via yarn-end between twist funnel and rotor wall, and yarn formation is achieved.
